(19) United States
(12) Patent Application Publication
(10) Pub. No.: US 2025/0269667 A1
(43) Pub. Date: Aug. 28, 2025

(54) RECORDING DEVICE AND CUTTER UNIT

(71) Applicant: SEIKO EPSON CORPORATION, Tokyo (JP)

(72) Inventors: Satoshi NAKATA, MATSUMOTO-SHI (JP); Kanji MOMOSE, MATSUMOTO-SHI (JP); Katsumi MARUYAMA, AZUMINO-SHI (JP); Masanari TANAKA, SHIOJIRI-SHI (JP); Hirokazu ANADA, MATSUMOTO-SHI (JP); Katsumi YAMADA, MATSUMOTO-SHI (JP); Soshi AKASAKA, SHIOJIRI-SHI (JP)

(21) Appl. No.: 19/057,570

(22) Filed: Feb. 19, 2025

(30) Foreign Application Priority Data
Feb. 22, 2024 (JP) 2024-025333

(51) Int. Cl. B41J 11/70; B26D 1/18; G03G 15/00

(52) U.S. Cl. CPC B41J 11/706; B26D 1/185; G03G 15/6523; G03G 2215/00814

(57) ABSTRACT

A recording device includes a transport section that transports a medium in a transport direction along a transport path, a recording section that records an image on the medium transported by the transport section, a cutter unit including a cutter blade for processing the medium in the transport path, and a cutter carriage configured to move the cutter unit in a widthwise direction intersecting the transport direction, wherein the cutter unit is attachable to and detachable from the cutter carriage, and the cutter unit enters an exposed state in which the cutter blade becomes exposed in accordance with an attachment operation of attaching the cutter unit to the cutter carriage, and enters a non-exposed state in which the cutter blade is not exposed in accordance with a detachment operation of detaching the cutter unit from the cutter carriage.

The present application is based on, and claims priority from JP Application Serial Number 2024-025333, filed Feb. 22, 2024, the disclosure of which is hereby incorporated by reference herein in its entirety.

### BACKGROUND

### 1. Technical Field

The present disclosure relates to a recording device and a cutter unit.

### 2. Related Art

For example, as described in JP-A-2013-86235, in a recording device that performs recording on a medium transported along a transport path, the medium is processed by a cutter blade. In such a recording device, a cutter holder that accommodates the cutter blade is configured to be attachable to and detachable from a cutter base that holds the cutter holder.

However, in such a recording device, the cutter blade is exposed. Therefore, it is desirable to improve safety with respect to the cutter blade when the cutter blade is replaced.

### SUMMARY

A recording device that solves the above problem includes a transport section that transports a medium in a transport direction along a transport path; a recording section that records an image on the medium transported by the transport section; a cutter unit including a cutter blade for processing the medium in the transport path; and a cutter carriage configured to move the cutter unit in a widthwise direction intersecting the transport direction, wherein the cutter unit is attachable to and detachable from the cutter carriage and, in accordance with an attachment operation of attaching the cutter unit to the cutter carriage, the cutter unit enters an exposed state in which the cutter blade becomes exposed and, in accordance with a detachment operation of detaching the cutter unit from the cutter carriage, enters a non-exposed state in which the cutter blade is not exposed. A cutter unit is attachable to and detachable from a cutter carriage with respect to a recording device, the recording device including a transport section that transports a medium in a transport direction along a transport path, a recording section that records an image on the medium transported by the transport section, and the cutter carriage, which moves the cutter unit in a widthwise direction intersecting the transport direction, wherein the cutter unit includes a cutter blade for processing the medium in the transport path, wherein the cutter unit enters an exposed state in which the cutter blade becomes exposed in accordance with an attachment operation of attaching the cutter unit to the cutter carriage, and enters a non-exposed state non-exposed state in which the cutter blade is not exposed in accordance with a detachment operation of detaching the cutter unit from the cutter carriage.

### BRIEF DESCRIPTION OF THE DRAWINGS

FIG. 1 is a perspective view showing a recording device of a first embodiment.

FIG. 2 is a perspective view showing an accommodation cassette of the first embodiment.

FIG. 3 is a perspective view showing the recording device of the first embodiment.

FIG. 4 is an explanatory diagram illustrating the recording device of the first embodiment.

FIG. 5 is a perspective view showing a cutting section of the first embodiment.

FIG. 6 is a perspective view showing the cutting section of the first embodiment.

FIG. 7 is a side view showing the cutting section of the first embodiment.

FIG. 8 is a top view showing a cutter unit of the first embodiment.

FIG. 9 is a cross-sectional view showing the cutter unit and the cutter carriage of the first embodiment.

FIG. 10 is a cross-sectional view showing the cutter unit and a cutter carriage of the first embodiment.

FIG. 11 is a cross-sectional view showing the cutter unit and the cutter carriage of the first embodiment.

FIG. 12 is a cross-sectional view showing the cutter unit and the cutter carriage of the first embodiment.

FIG. 13 is a perspective view showing a cutter unit according to a second embodiment.

FIG. 14 is a cross-sectional view showing the cutter unit of the second embodiment.

FIG. 15 is a cross-sectional view showing the cutter unit and a cutter carriage of the second embodiment.

FIG. 16 is a cross-sectional view showing the cutter unit and the cutter carriage of the second embodiment.

FIG. 17 is a perspective view showing a cutter unit of a third embodiment.

FIG. 18 is a top view showing the cutter unit and a cutter carriage of the third embodiment.

FIG. 19 is a cross-sectional view showing the cutter unit of the third embodiment.

FIG. 20 is a cross-sectional view showing the cutter unit and the cutter carriage of the third embodiment.

FIG. 21 is a cross-sectional view showing the cutter unit and the cutter carriage of the third embodiment.

FIG. 22 is a side view showing a cutter unit and a cutter carriage of a fourth embodiment.

### DESCRIPTION OF EMBODIMENTS

### First Embodiment

Hereinafter, an embodiment of a recording device will be described. In the following description, a direction intersecting the vertical direction Z is referred to as a widthwise direction X, and a direction intersecting the vertical direction Z and the widthwise direction X is referred to as a forward-rearward direction Y. One of the widthwise directions X is referred to as the first widthwise direction X1 and the other widthwise direction X is referred to as the second widthwise direction X2. One of the forward-rearward directions Y is referred to as the forward direction Y1 and the other forward-rearward direction Y is referred to as rearward direction Y2. Of the vertical directions Z, the upward direction is referred to as the upward direction Z1 and the downward direction is referred to as the downward direction Z2.

### Configuration of Recording Device 10

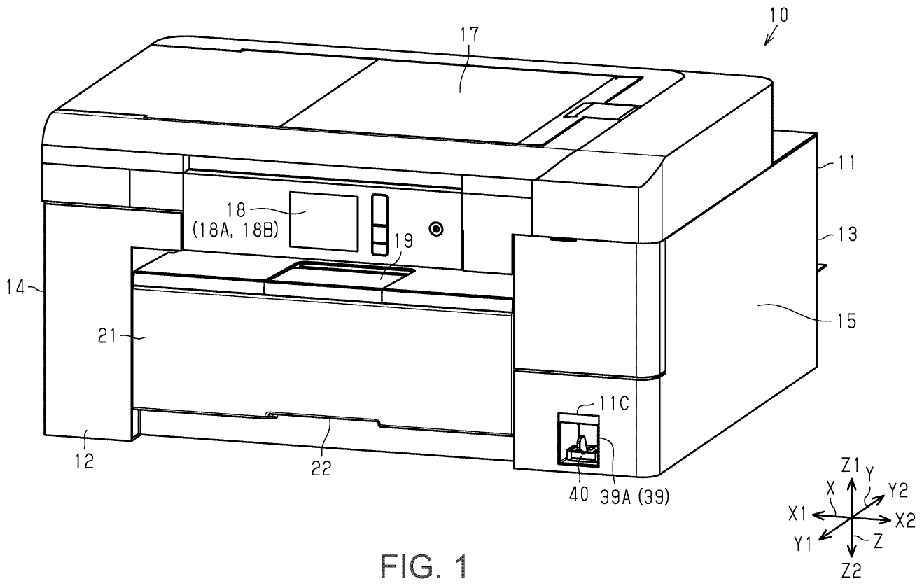

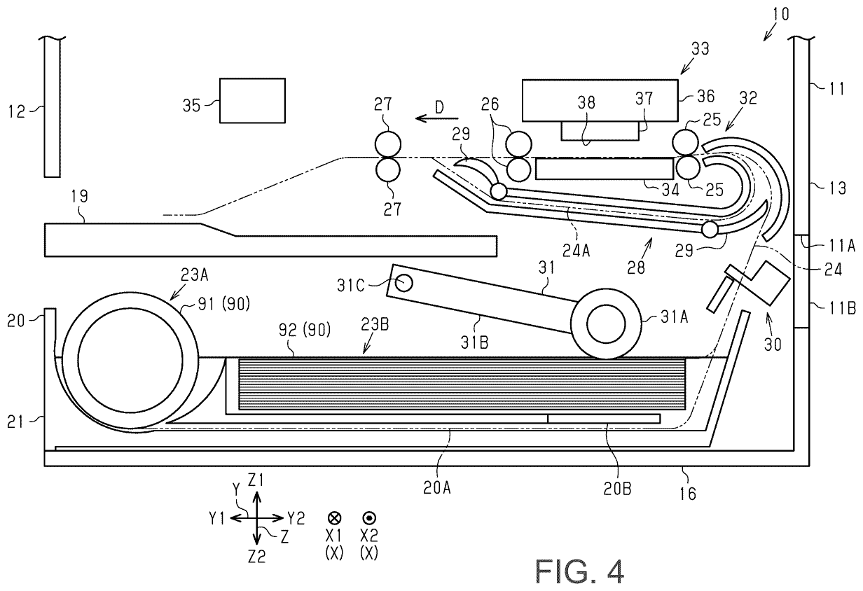

As shown in FIG. 1, a recording device 10 is a device that records an image on a medium 90 shown in FIG. 4. The recording device 10 may be a device that records an image on the medium 90 by ejecting liquid. The liquid may be, for example, ink. The liquid may be, for example, in a plurality of colors or in one color. The medium 90 may be, for example, roll paper 91 and paper sheets 92 as illustrated in FIG. 4. The roll paper 91 is a roll-shaped medium 90. The paper sheets 92 are a sheet-like medium 90. The paper sheets 92 are plain paper. The recording device 10 may be a device capable of performing recording on a plurality of types of medium 90.

The recording device 10 includes a housing 11. The housing 11 is the exterior of the recording device 10. The housing 11 constitutes a front surface 12, a rear surface 13, a left side surface 14, a right side surface 15, a bottom surface 16, and a top surface 17 of the recording device 10, but is not limited to these. The housing 11 may constitute at least a part of the front surface 12, a part of the rear surface 13, a part of the left side surface 14, a part of the right side surface 15, a part of the bottom surface 16, and a part of the top surface 17 of the recording device 10. The housing 11 accommodates various components that make up the recording device 10.

The recording device 10 includes an operation panel 18. The operation panel 18 may be provided on the front surface 12. The operation panel 18 may be a touch panel. The operation panel 18 may include an operation section 18A and a display section 18B. The operation section 18A can be operated by a user. The operation section 18A may include a plurality of operation regions. The display section 18B displays information related to the recording device 10.

The recording device 10 includes a discharge tray 19. The discharge tray 19 is a tray on which the medium 90 is placed after being recorded on and discharged. The discharge tray 19 is accessible from the forward direction Y1. The discharge tray 19 may be configured to be extendable in the forward-rearward direction Y.

The recording device 10 includes an accommodation cassette 20. The accommodation cassette 20 constitutes a part of the front surface 12. The accommodation cassette 20 is stored in the housing 11. The accommodation cassette 20 is displaceable in the forward-rearward direction Y. The accommodation cassette 20 can supplied with paper by being moved from the housing 11 in the forward direction Y1. The accommodation cassette 20 stores the medium 90.

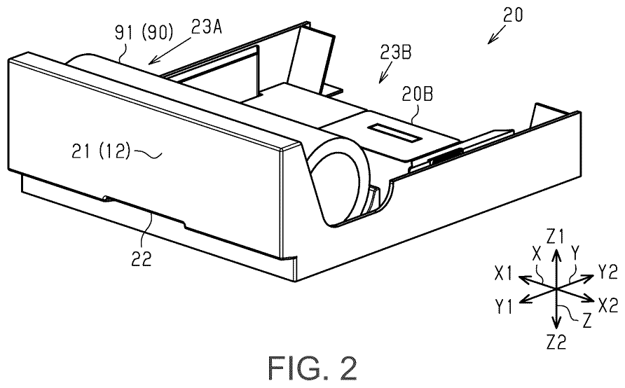

As shown in FIG. 2, the accommodation cassette 20 includes a front section 21, a cassette gripping section 22, a first accommodation section 23A, and a second accommodation section 23B. The front section 21 is a wall section located in the forward direction Y1. The front section 21 constitutes a part of the front surface 12. The cassette gripping section 22 is provided on the front section 21. The cassette gripping section 22 can be gripped by a user.

The first accommodation section 23A is configured to store the roll paper 91 as the medium 90. The roll paper 91 corresponds to an example of a first medium. The second accommodation section 23B is configured to accommodate the paper sheet 92 illustrated in FIG. 4 as the medium 90. The paper sheet 92 corresponds to an example of a second medium. It is configured capable of feeding at least one of the roll paper 91 placed in the first accommodation section 23A and the paper sheet 92 placed in the second accommodation section 23B.

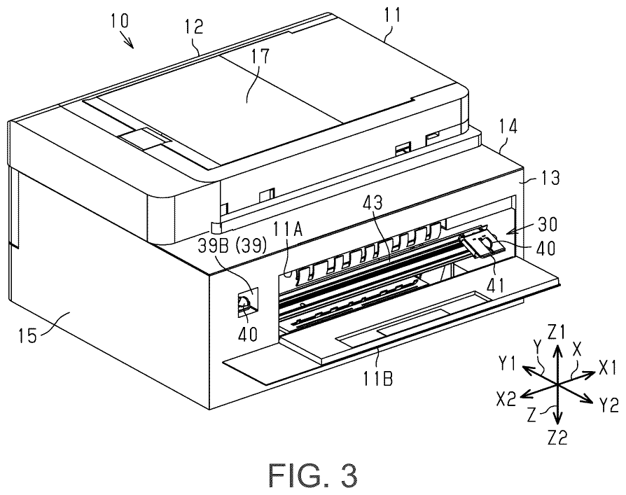

As shown in FIG. 3, the housing 11 includes an opening section 11A and an openable cover 11B. The opening section 11A is provided in the rear surface 13. The opening section 11A allows access to a cutting section 30, which is accommodated in the housing 11.

The openable cover 11B is a cover that can open and close the opening section 11A. The openable cover 11B is pivotally attached in the downward direction Z2 from the opening section 11A, but is not limited thereto, and may be pivotally attached, for example, in the upward direction Z1 from the opening section 11A. In this way, the housing 11 enables access to the cutting section 30 via the opening section 11A by opening the openable cover 11B.

Specifically, for example, it is possible to resolve a jam of the medium 90 and perform maintenance on the cutting section 30. Maintenance of the cutting section 30 includes replacement of a cutter unit 40 (to be described later).

### Configuration of Replacement Unit Accommodation Section 39

As shown in FIGS. 1 and 3, the recording device 10 may include a replacement unit accommodation section 39. The replacement unit accommodation section 39 is provided within the housing 11. The replacement unit accommodation section 39 is, for example, a recessed space region formed in the housing 11. The replacement unit accommodation section 39 can accommodate a replacement cutter unit 40.

The recording device 10 may include a plurality of replacement unit accommodation sections 39. The recording device 10 may include a first replacement unit accommodation section 39A and a second replaceable unit accommodation section 39B as the plurality of replacement unit accommodation sections 39.

As shown in FIG. 1, the first replacement unit accommodation section 39A is provided on the front surface 12 side of the housing 11. A replacement cutter unit 40 can be accommodated in the first replacement unit accommodation section 39A.

The housing 11 includes an accommodation cover 11C. The accommodation cover 11C constitutes the front surface 12 of the housing 11. The accommodation cover 11C is displaceable so as to open and close the first replacement unit accommodation section 39A. The replacement cutter unit 40 accommodated in the first replacement unit accommodation section 39A can be accessed from the forward direction Y1 side in a state where the accommodation cover 11C is opened.

As shown in FIG. 3, the second replaceable unit accommodation section 39B is provided on the rear surface 13 side of the housing 11. A replacement cutter unit 40 can be accommodated in the second replaceable unit accommodation section 39B.

The openable cover 11B can be displaced so as to open and close the second replaceable unit accommodation section 39B. The replacement cutter unit 40 that is accommodated in the second replaceable unit accommodation section 39B can be accessed from the rearward direction Y2 side while the openable cover 11B is opened.

### Configuration of Feeding Section 31

As illustrated in FIG. 4, the recording device 10 includes the cutting section 30, a feeding section 31, a transport section 32, a recording section 33, a medium support section 34, and a control section 35. When the accommodation cassette 20 is mounted in the housing 11, the feeding section 31 is positioned in the upward direction Z1 from the accommodation cassette 20. The feeding section 31 is configured to feed the medium 90 placed on the accommodation cassette 20.

The feeding section 31 includes a feed roller 31A and a roller support section 31B. The feed roller 31A is a roller for feeding the medium 90. The roller support section 31B is pivotally mounted at its base end section so as to be rotatable about a rotation shaft 31C. The rotation shaft 31C extends in the widthwise direction X. The roller support section 31B is configured to rotatably support the feed roller 31A at the tip end section thereof. The roller support section 31B is inclined so that the feed roller 31A abuts the medium 90.

The accommodation cassette 20 includes a feed path 20A for the roll paper 91. The feed path 20A is positioned in the downward direction Z2 from the first accommodation section 23A and the second accommodation section 23B. The feed path 20A is a path that connects the first accommodation section 23A and a transport path 24 (to be described later).

The accommodation cassette 20 includes a feed flap 20B. The feed flap 20B is provided on a support plate of the second accommodation section 23B. The feed flap 20B is displaced to a paper sheet position and to a roll paper position. The feed flap 20B may be displaced by rotation or by sliding.

The paper sheet position is the position when recording is to be performed on the paper sheets 92 accommodated in the second accommodation section 23B. The paper sheet position is the position at which the paper sheets 92 stored in the second accommodation section 23B are supported by closing an opening or a notch provided in the bottom plate of the second accommodation section 23B.

The roll paper position is the position when recording is to be performed on the roll paper 91 accommodated in the first accommodation section 23A. The roll paper position is a position at which the feed roller 31A is brought into contact with the roll paper 91 in the feed path 20A by opening the opening or the notch provided in the bottom plate of the second accommodation section 23B.

When a paper sheet 92 is stored in the second accommodation section 23B, the feed roller 31A comes into contact with the paper sheet 92 due to the inclination of the roller support section 31B. More specifically, the feed roller 31A contacts the uppermost paper sheet 92 stored in the second accommodation section 23B, that is, the paper sheet 92 placed furthest in the upward direction Z1. The feed roller 31A rotates in the feed direction while in contact with the paper sheets 92, thereby feeding out paper sheets 92 one sheet at a time. In this case, the feed flap 20B is arranged in the paper sheet position. Therefore, the second accommodation section 23B can stably store the paper sheets 92.

When the feed flap 20B is positioned at the roll paper position and no paper sheets 92 are stored in the second accommodation section 23B, the feed roller 31A is brought into contact with the roll paper 91 positioned in the feed path 20A due to the inclination of the roller support section 31B. The feed roller 31A rotates in the feed direction while in contact with the roll paper 91 in the feed path 20A to feed the roll paper 91 that the feed roller 31A contacts.

### Configuration of Transport Section 32

The transport section 32 is configured to transport the medium 90. The transport section 32 transports the medium 90 that was fed out by the feeding section 31, in the transport direction D along the transport path 24. The transport path 24 is a path for transporting the medium 90.

The transport path 24 may include a path for transporting the roll paper 91 and a path for transporting the paper sheet 92. The transport path 24 may include an inversion path 24A for turning the medium 90 over. The inversion path 24A is a path for transporting the medium 90 that was inverted by an inversion section 28 (to be described later).

The transport section 32 includes a plurality of rollers and a plurality of motors serving as drive sources. In particular, the transport section 32 includes a transport roller pair 25. The transport roller pair 25 is located upstream of the medium support section 34 in the transport path 24. The transport roller pair 25 transports the medium 90 along the transport path 24 to the medium support section 34.

The transport section 32 includes a first discharge roller pair 26 and a second discharge roller pair 27. The first discharge roller pair 26 and the second discharge roller pair 27 are located downstream of the medium support section 34 in the transport path 24. The second discharge roller pair 27 is positioned downstream of the first discharge roller pair 26 in the transport path 24. The first discharge roller pair 26 and the second discharge roller pair 27 discharge the medium 90 after recording along the transport path 24.

The transport section 32 may include the inversion section 28. That is, the recording device 10 includes the inversion section 28. The inversion section 28 is configured to invert the medium 90 after recording. The second discharge roller pair 27 rotates in a direction opposite to the rotation direction in which the medium 90 is discharged, thereby transporting the medium 90 along the inversion path 24A to the inversion section 28. The inversion section 28 is configured to invert the printed-on medium 90 that was transported to the second discharge roller pair 27.

The inversion section 28 includes an inversion flap 29. The inversion flap 29 is provided at a position along the inversion path 24A. The inversion flap 29 switches the direction in which the medium 90 is transported. In particular, the inversion flap 29 switches whether or not to cause the medium 90 to travel along the inversion path 24A. In this manner, the inversion section 28 causes the recorded-on and inverted medium 90 to enter the transport path 24 further upstream than the medium support section 34.

By this, the medium 90 with an image recorded on the front surface of the medium 90 is transported to the medium support section 34 in a state of having been inverted by the inversion section 28. By this, an image can also be recorded on the rear surface of the medium 90 by the recording section 33. In this way, the recording section 33 can perform recording on both surfaces of the medium 90. That is, recording section 33 can perform double-sided printing.

### Configuration of Recording Section 33

The recording section 33 is configured to record an image on the medium 90. The recording section 33 may be configured to record an image on the medium 90 by ejecting liquid onto the medium 90. The recording section 33 is positioned in the upward direction Z1 from the medium support section 34.

The recording section 33 includes a recording carriage 36 and a liquid ejection head 37. The recording carriage 36 supports the liquid ejection head 37 from the upward direction Z1. The liquid ejection head 37 is provided in the downward direction Z2 portion from the recording carriage 36.

The liquid ejection head 37 includes a nozzle surface 38. The nozzle surface 38 is a surface facing in the downward direction Z2. The nozzle surface 38 is a surface facing the medium support section 34. The nozzle surface 38 is a surface in which a plurality of nozzles (not shown) are opened. Each of the plurality of nozzles opens toward the medium 90 supported by the medium support section 34. Each of the plurality of nozzles discharges liquid.

The liquid ejection head 37 ejects liquid from the plurality of nozzles toward the medium 90 supported by the medium support section 34. In this way, the recording section 33 is configured to perform recording on the medium 90 by ejecting liquid onto the medium 90. The liquid ejection head 37 is a serial head type which ejects liquid in accordance with the movement of the recording carriage 36 in the widthwise direction X, but it may also be a line head type.

The medium support section 34 is configured to support the medium 90. In particular, the medium support section 34 supports the medium 90 in a recording region in which recording is performed on the medium 90 by the recording section 33. That is, the medium support section 34 supports the medium 90 on which recording is performed by the recording section 33.

### Configuration of Control Section 35

The control section 35 controls the recording device 10. The control section 35 controls each unit in the recording device 10. The control section 35 controls various operations performed by the recording device 10. The control section 35 may be communicably connected to a terminal device (not shown).

The control section 35 can be configured as a circuit including α: one or more processors that execute various processes in accordance with a computer program, β: one or more dedicated hardware circuits that execute at least some of the various processes, or γ: a combination of these. The hardware circuit is, for example, an application specific integrated circuit. The processor includes a CPU and memory, such as RAM and ROM, which stores program code or instructions configured to cause the CPU to perform processes. Memory, or computer-readable medium, includes any readable medium that can be accessed by a general purpose or special purpose computer.

### Configuration of Cutting Section 30

The cutting section 30 is configured to cut the medium 90. The cutting section 30 is provided at the rear surface 13 side of the recording device 10. The cutting section 30 is provided at a position along the transport path 24. The cutting section 30 is configured to cut the roll paper 91 transported along the transport path 24 in the widthwise direction X.

The cutting section 30 is provided at a position along the transport path 24 between the feeding section 31 and the recording section 33, but may also be provided at a position along the transport path 24 between the recording section 33 and the discharge tray 19.

The cutting section 30 is located at the forward direction Y1 side of the opening section 11A. The cutting section 30 is exposed through the opening section 11A when the openable cover 11B is open. By this, the cutting section 30 can be accessed by the user via the opening section 11A when the openable cover 11B is open.

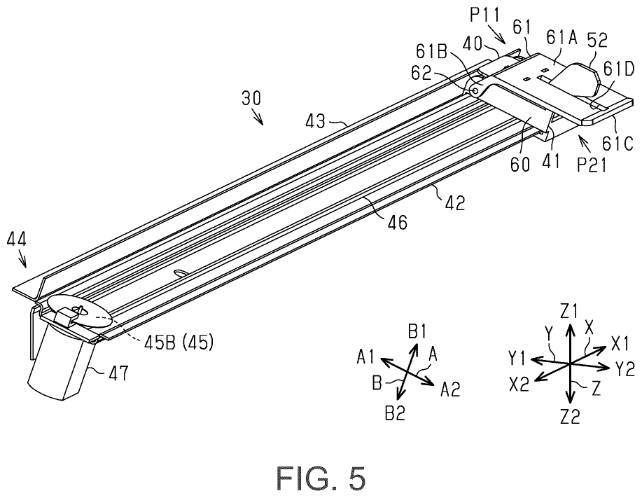

As shown in FIG. 5, the cutting section 30 includes the cutter unit 40, a cutter carriage 41, a carriage support section 42, a fixed blade 43, and a carriage movement section 44. That is, the recording device 10 includes the cutter unit 40, the cutter carriage 41, the carriage support section 42, the fixed blade 43, and the carriage movement section 44.

The cutter unit 40 is a unit for cutting the medium 90. The cutter unit 40 is mounted on the cutter carriage 41. The cutter unit 40 is attachable to and detachable from the cutter carriage 41. In other words, the cutter carriage 41 can have the cutter unit 40 attached to it and detached from it.

The cutting section 30 is arranged so that the cutter blade 50 protrudes along an advance/retract direction A. The direction in which the cutter blade 50 protrudes in the advance/retract direction A is referred to as the advance direction A1, and a direction opposite to the advance direction A1 is referred to as the retraction direction A2. The advance/retract direction A is a direction intersecting the transport direction D and the widthwise direction X. The advance/retract direction A is a direction inclined upward toward forward direction Y1. A direction intersecting the advance/retract direction A and the widthwise direction X is referred to as an intersecting direction B. A direction toward the upward direction Z1 side in the intersecting direction B is referred to as the first intersecting direction B1, and a direction opposite to the first intersecting direction B1 is referred to as the second intersecting direction B2. The cutting section 30 may be disposed such that the cutter blade 50 protrudes in the forward direction Y1. In this case, the advance/retract direction A coincides with the forward-rearward direction Y and the intersecting direction B coincides with the vertical direction Z.

In a state of being supported by the carriage support section 42, the cutter carriage 41 is movable along the widthwise direction X by driving force from the carriage movement section 44. In a state in which the cutter unit 40 is mounted, the cutter carriage 41 moves the cutter unit 40 in the widthwise direction X, which intersects the transport direction D.

At least the cutter unit 40 and the cutter carriage 41 are accommodated in the housing 11. That is, the housing 11 accommodates at least the cutter unit 40 and the cutter carriage 41. At least the cutter unit 40 and the cutter carriage 41 are accessible through the opening section 11A. That is, the housing 11 enables, via the opening section 11A, a detachment operation of detaching the cutter unit 40 from the cutter carriage 41 and an attachment operation of attaching the cutter unit 40 to the cutter carriage 41.

The carriage support section 42 extends in the widthwise direction X. The carriage support section 42 is configured to support the cutter carriage 41. The carriage support section 42 guides the cutter carriage 41 so as to be movable along the widthwise direction X.

The fixed blade 43 extends in the widthwise direction X. The fixed blade 43 may be configured in an L shape as viewed from the first widthwise direction X1. The fixed blade 43 is provided at a position facing the cutter blade 50 of the cutter unit 40 with the transport path 24 interposed therebetween. In this manner, the cutter blade 50 and the fixed blade 43 cut the medium 90 transported along the transport path 24.

The carriage movement section 44 includes a pair of pulleys 45, a timing belt 46, and a carriage drive section 47. The pair of pulleys 45 is provided at both end sections of the carriage support section 42 in the widthwise direction X. The pair of pulleys 45 includes a first pulley (not shown) and a second pulley 45B. The first pulley is provided at the end section of the carriage support section 42 in the first widthwise direction X1. The second pulley 45B is provided at the end section of the carriage support section 42 in the second widthwise direction X2.

The timing belt 46 is wound around the pair of pulleys 45. The timing belt 46 may be an endless belt. The timing belt 46 is connected to the cutter carriage 41.

The carriage drive section 47 is a drive source for moving the cutter carriage 41 in the widthwise direction X. The carriage drive section 47 may be a motor. The carriage drive section 47 may be provided at the end section of the carriage support section 42 in the second widthwise direction X2. The carriage drive section 47 may rotate the second pulley 45B via a transmission member (not shown). By this, the carriage drive section 47 moves the cutter carriage 41 in the widthwise direction X.

The cutting section 30 may include a position detection section (not shown). The position detection section detects the position of the cutter carriage 41 in the widthwise direction X. The position detection section may be an encoder that detects the position of the cutter carriage 41 by detecting the amount of rotation of at least one of the pair of pulleys 45. The position detection section may be an encoder that detects the position of the cutter carriage 41 by detecting position information of the cutter carriage 41 in the widthwise direction X. The position detection section outputs a signal indicating a detection result to control section 35.

### Configuration of Cutter Unit 40

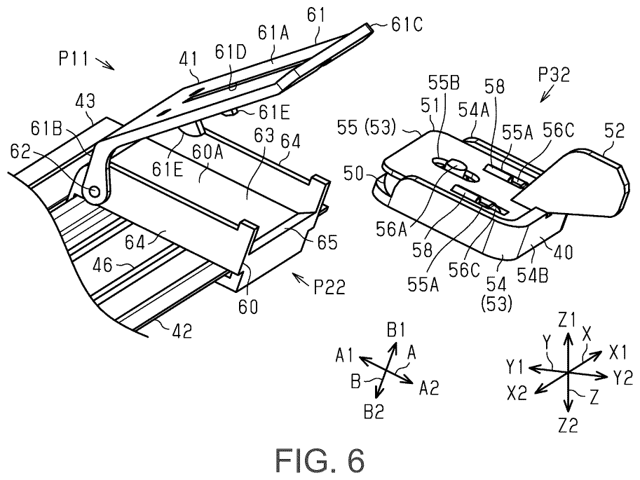

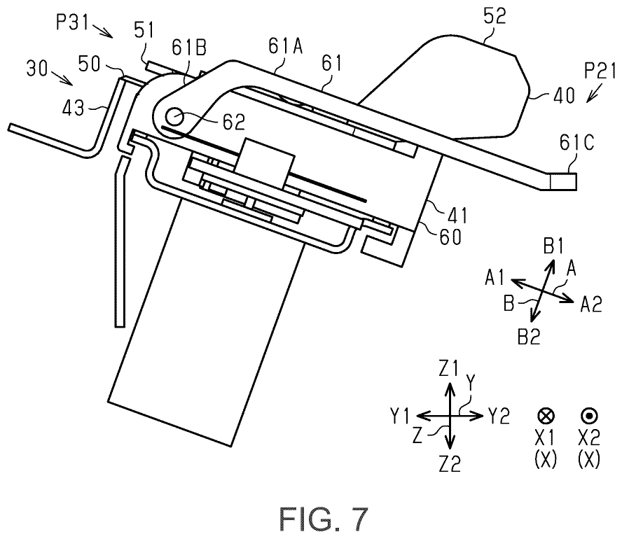

As shown in FIGS. 6 and 7, the cutter unit 40 includes the cutter blade 50 and a cutter accommodation section 51. The cutter blade 50 is a member for cutting the medium 90 in the transport path 24. The cutter accommodation section 51 can accommodate the cutter blade 50.

The cutter accommodation section 51 includes a positioning section 52. The positioning section 52 is a member for positioning the cutter unit 40 with respect to the cutter carriage 41. The positioning section 52 is configured to protrude in the first intersecting direction B1. The positioning section 52 may have a plate shape extending along the advance/retract direction A and the intersecting direction B. The positioning section 52 is also a part for gripping the cutter unit 40.

### Configuration of Cutter Carriage 41

As shown in FIGS. 5 and 6, the cutter carriage 41 is movable along the widthwise direction X from a standby position P11. The standby position P11 is located on the first widthwise direction X1 side. The standby position P11 is a home position in which the cutter carriage 41 waits while the cutting section 30 is not operating.

The cutter carriage 41 includes a unit holding section 60 and a unit fixing section 61. The unit holding section 60 holds the cutter unit 40. The unit holding section 60 is movable along the widthwise direction X by driving force from the carriage movement section 44.

As shown in FIG. 6, the unit holding section 60 includes a unit support section 63, a pair of unit guide sections 64, and an inclined section 65. The unit support section 63 is configured to support the cutter unit 40 from the second intersecting direction B2 when the cutter unit 40 is mounted on the cutter carriage 41. The upper surface of the unit support section 63 is a flat surface. The unit support section 63 may have a flat plate shape.

The pair of unit guide sections 64 are provided at both end sections of the unit support section 63 in the widthwise direction X. The unit guide section 64 is a wall section that protrudes in the first intersecting direction B1. The pair of unit guide sections 64 guide the cutter unit 40 to be movable along the advance/retract direction A.

When the cutter unit 40 is mounted on the cutter carriage 41, the cutter unit 40 is held in the holding region 60A. The holding region 60A is a region surrounded by the unit support section 63 and the pair of unit guide sections 64. As described above, the holding region 60A is a region where the cutter unit 40 is held when the cutter unit 40 is mounted on the cutter carriage 41. That is, the holding region 60A is a mounting region in which the cutter unit 40 is mounted.

The unit holding section 60 is open in the advance direction A1 of the holding region 60A. Therefore, when the cutter unit 40 is mounted on the cutter carriage 41, the cutter blade 50 is such that the cutter blade 50 can be exposed toward the transport path 24.

The inclined section 65 is provided at a retraction direction A2 portion of the unit support section 63. The inclined section 65 is configured to be inclined with respect to the unit support section 63. The inclined section 65 is inclined downward toward the advance direction A1. The inclined section 65 is configured so that when the cutter unit 40 is detached from the cutter carriage 41, the inclined section 65 comes into contact with the end section of the cutter unit 40 in the retraction direction A2.

Together with the unit holding section 60, the unit fixing section 61 fixes the cutter unit 40 in place by contacting the cutter unit 40, which is held by the unit holding section 60, from the first intersecting direction B1. That is, the unit fixing section 61 fixes the cutter unit 40 in place when the cutter unit 40 is mounted in the cutter carriage 41.

The unit fixing section 61 includes a main body section 61A, a pair of arm sections 61B, and a gripping section 61C. The main body section 61A has a flat plate shape. The main body section 61A is a part for fixing the cutter unit 40 in place by contacting the cutter unit 40 held by the unit holding section 60 from the first intersecting direction B1.

The arm sections 61B are provided at the advance direction A1 portion of the main body section 61A. The pair of arm sections 61B are aligned in the widthwise direction X. An opening is provided at the tip end section of the arm section 61B, and a coupling shaft 62 provided on the main body section 61A is inserted into the opening. The coupling shaft 62 is a shaft that protrudes outward along the widthwise direction X from the unit holding section 60. By this, the unit fixing section 61 is rotatable with respect to the unit holding section 60 about an axis of rotation along the widthwise direction X.

As shown in FIGS. 5 and 6, the unit fixing section 61 is movable between a fixed position P21 and a release position P22. That is, the unit fixing section 61 is rotatable between the fixed position P21 and the release position P22 around the coupling shaft 62 in a state in which the cutter unit 40 is mounted.

The fixed position P21 is a position at which the cutter unit 40 held by the unit holding section 60 is fixed. The fixed position P21 is a position at which the unit fixing section 61 contacts the cutter unit 40 held by the unit holding section 60 from the first intersecting direction B1 side.

The release position P22 is a position in which the cutter unit 40 held by the unit holding section 60 is not fixed and the fixing of the cutter unit 40 is released. The release position P22 is a position in which the unit fixing section 61 does not contact, from the first intersecting direction B1, the cutter unit 40 that is held by the unit holding section 60. The release position P22 is a position at which the cutter unit 40 held by the unit holding section 60 can be attached and detached.

The gripping section 61C is provided at the retraction direction A2a side of the main body section 61A. The gripping section 61C is a part that can be gripped by a user when the unit fixing section 61 is to be moved. In this way, the unit fixing section 61 is movable by being gripped by the user.

The main body section 61A is provided with a positioning opening section 61D. The positioning opening section 61D extends along the advance/retract direction A. While the cutter unit 40 is held by the unit holding section 60, the positioning section 52 enters into and is retracted from the positioning opening section 61D by movement of the unit fixing section 61 between the fixed position P21 and the release position P22.

When the unit fixing section 61 is disposed at the fixed position P21 while the cutter unit 40 is held by the unit holding section 60, the positioning section 52 is inserted into the positioning opening section 61D. By this, when the cutter unit 40 is mounted on the cutter carriage 41, the cutter unit 40 is positioned on the cutter carriage 41.

As shown in FIG. 6, the main body section 61A includes a protrusion section 61E. The main body section 61A may include a pair of protrusion sections 61E. The pair of protrusion sections 61E are provided at both widthwise direction X end sections of the main body section 61A. The protrusion sections 61E have an arc shape in the advance direction A1. The protrusion sections 61E are configured to protrude in the second intersecting direction B2 when the unit fixing section 61 is disposed at the fixed position P21.

The protrusion sections 61E come into contact with the cutter unit 40 when the cutter unit 40 is mounted on the cutter carriage 41. By this, the protrusion section 61E fixes the cutter unit 40 to the cutter carriage 41.

The attachment operation of attaching the cutter unit 40 to the cutter carriage 41 includes an operation of disposing the cutter unit 40 on the cutter carriage 41 and an operation of moving the unit fixing section 61 to the fixed position P21. The detachment operation of detaching the cutter unit 40 from the cutter carriage 41 includes an operation of moving the unit fixing section 61 to the release position P22 and an operation of taking the cutter unit 40 out from the cutter carriage 41.

### Configuration of Cutter Accommodation Section 51

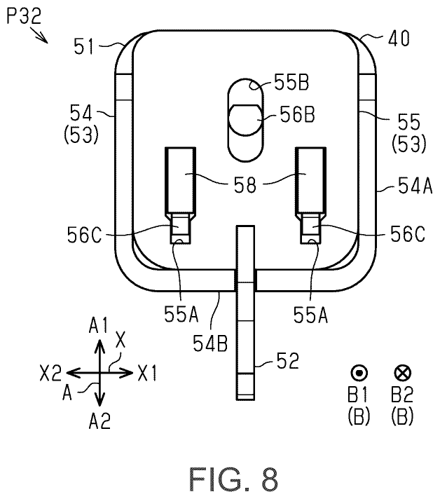

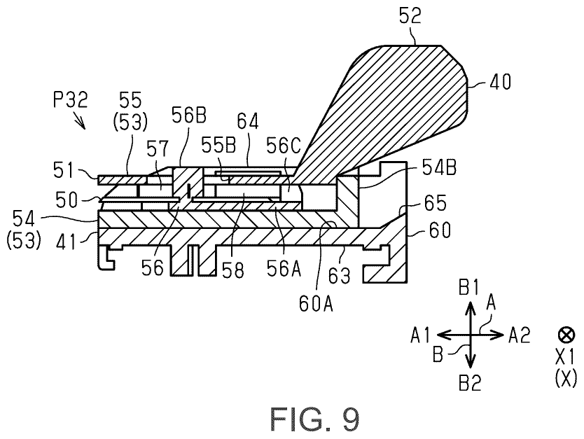

As shown in FIGS. 8 and 9, the cutter accommodation section 51 includes a cutter case 53, a base section 56, a fixing member 57, and biasing sections 58. That is, the cutter unit 40 includes the cutter case 53, the base section 56, the fixing member 57, and the biasing sections 58. The cutter accommodation section 51 may include a pair of biasing sections 58.

The cutter case 53 is configured to accommodate the cutter blade 50, the base section 56, the fixing member 57, and the biasing sections 58. The cutter case 53 includes a case 54 and a cover 55. That is, the cutter unit 40 includes the case 54 and the cover 55.

The case 54 is configured to support the base section 56 from the second intersecting direction B2 side. The case 54 is configured to accommodate the cutter blade 50, the base section 56, the fixing member 57, and the biasing sections 58.

The case 54 includes a base guide section 54A. The base guide section 54A is a wall section provided so as to protrude from the case 54 in the first intersecting direction B1. The base guide section 54A is provided at both end sections of the case 54 in the widthwise direction X and at the end section of the case 54 in the retraction direction A2. The base guide section 54A guides the base section 56 to move along the advance/retract direction A. The base guide section 54A constitutes the end section 54B of the case 54 in the retraction direction A2.

The cover 55 is provided on the first intersecting direction B1 portion of the case 54. The cover 55 is fixed to the case 54. The cover 55 is configured to cover the base section 56 from the first intersecting direction B1. The cover 55 is configured to accommodate the cutter blade 50, the base section 56, the fixing member 57, and the biasing sections 58 together with the case 54. The cover 55 includes the positioning section 52.

The cover 55 includes a first opening section 55A. The cover 55 may include a pair of first opening sections 55A. The pair of first opening sections 55A is arranged in the widthwise direction X. The first opening section 55A is provided so as to penetrate the cover 55 in the intersecting direction B. The first opening section 55A is provided at the retraction direction A2 side of the cover 55.

The first opening section 55A may be an elongated hole extending along the advance/retract direction A. A contact section 56C (to be described later) is inserted into the first opening section 55A. The first opening section 55A may have a shape that enables the contact section 56C to move in the advance/retract direction A. The biasing sections 58 may be held in the first opening sections 55A along the advance/retract direction A.

The first opening section 55A is provided so that the protrusion section 61E can be inserted into it and removed from it. When the unit fixing section 61 is disposed in the fixed position P21, the protrusion section 61E is inserted into the first opening section 55A. By this, the unit fixing section 61 fixes the cutter unit 40 to the cutter carriage 41.

When the unit fixing section 61 is disposed at the release position P22, the protrusion section 61E separates from the first opening section 55A. By this, the unit fixing section 61 releases the fixed state of the cutter unit 40 to the cutter carriage 41.

The cover 55 includes a second opening section 55B. The second opening section 55B is provided in the advance direction A1 side of the cover 55. The second opening section 55B is provided so as to penetrate the cover 55 along the intersecting direction B.

The second opening section 55B may be an elongated hole extending along the advance/retract direction A. The cutter holding section 56B (to be described later) is inserted into the second opening section 55B. The second opening section 55B may have a shape that enables the cutter holding section 56B to move in the advance/retract direction A.

The base section 56 is configured to hold the cutter blade 50. The base section 56 is movable in the cutter case 53 along the advance/retract direction A. In this way, the cutter blade 50 held by the base section 56 moves along the advance/retract direction A by the base section 56 moving along the advance/retract direction A.

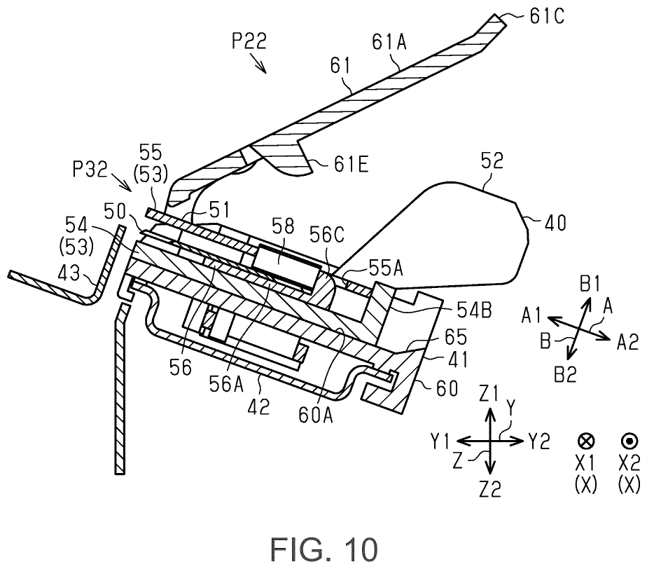

As shown in FIGS. 10 to 12, while accommodated in the cutter case 53, the base section 56 is movable between an exposed position P31 and a non-exposed position P32 along the advance/retract direction A. The exposed position P31 is a position at which the cutter blade 50 is exposed. The non-exposed position P32 is a position in which the cutter blade 50 is not exposed.

As shown in FIGS. 8 and 9, the base section 56 includes a base body section 56A. The base body section 56A is configured to support the cutter blade 50 from the second intersecting direction B2. The base body section 56A has a flat plate shape. The base body section 56A is movable along the advance/retract direction Aby being guided by the base guide section 54A. That is, the base section 56 is movable in the advance/retract direction A while accommodated in the cutter case 53.

The base section 56 includes a cutter holding section 56B. The cutter holding section 56B is configured to protrude from the base body section 56A toward the first intersecting direction B1. The cutter holding section 56B is configured to hold the cutter blade 50. The cutter holding section 56B may be a shaft that holds the cutter blade 50.

The fixing member 57 is mounted on the cutter holding section 56B. The fixing member 57 fixes the cutter blade 50 to the base body section 56A by contacting the cutter blade 50 from the first intersecting direction B1. By this, the cutter blade 50 is fixed between the base body section 56A and the fixing member 57 while being held by the cutter holding section 56B.

The cutter holding section 56B is provided so as to be inserted into the second opening section 55B. When the base section 56 moves along the advance/retract direction A, the cutter holding section 56B moves along the second opening section 55B.

The base section 56 includes a contact section 56C. The base section 56 may include a pair of contact sections 56C. The pair of contact sections 56C are provided so as to be aligned in the widthwise direction X. The contact section 56C is provided at the retraction direction A2 side of the base body section 56A. The contact section 56C is configured to protrude in the first intersecting direction B1.

The contact section 56C is provided so as to be inserted into the first opening section 55A. The contact section 56C is configured to not to protrude from the front face of the cutter unit 40 in a state of being inserted into the first opening section 55A when the cutter unit 40 is mounted on the cutter carriage 41. The contact section 56C comes into contact with the cutter carriage 41 in accordance with an attachment operation of attaching the cutter unit 40 on the cutter carriage 41.

The pair of biasing sections 58 are provided so as to be aligned in the widthwise direction X. The biasing sections 58 are provided between the cutter case 53 and the base section 56. The biasing sections 58 may be provided between the case 54 and the contact section 56C. The biasing sections 58 may be provided so as to be accommodated in the first opening section 55A. The biasing section 58 is configured to bias the base section 56 in the retraction direction A2 with respect to the cutter case 53. The biasing section 58 may be a compression spring.

### Operation of the First Embodiment

The operation of the first embodiment will be described.

As shown in FIG. 10, when the unit fixing section 61 is at the release position P22, the attachment operation of the cutter unit 40 to the cutter carriage 41 is performed. Specifically, when the unit fixing section 61 is at the release position P22, the cutter unit 40 is disposed in the holding region 60A of the cutter carriage 41 from the retraction direction A2 side.

In such a case, the protrusion section 61E is not inserted into the first opening section 55A and does not contact the contact section 56C. By this, the cutter unit 40 is disposed at the non-exposed position P32 by the biasing force of the biasing section 58.

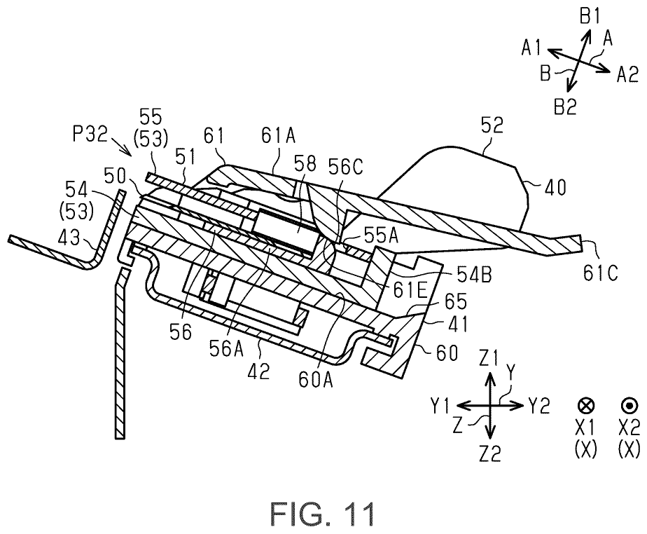

As shown in FIG. 11, when the unit fixing section 61 rotates from the release position P22 toward the fixed position P21, the protrusion section 61E is inserted into the first opening section 55A. By this, the protrusion section 61E comes into contact with the contact section 56C. That is, the contact section 56C comes into contact with the cutter carriage 41 in accordance with the attachment operation of the cutter unit 40 to the cutter carriage 41.

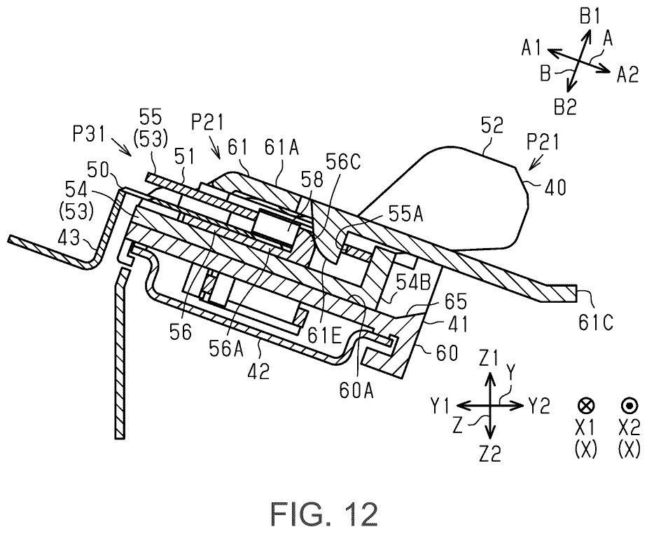

As shown in FIG. 12, when the unit fixing section 61 rotates from the release position P22 to the fixed position P21, the protrusion section 61E presses against the contact section 56C. In such a case, the base section 56 moves in the advance direction A1 against the biasing force of the biasing section 58. By this, the cutter unit 40 moves from the non-exposed position P32 to the exposed position P31 so that the cutter blade 50 held by the base section 56 is exposed from the cutter accommodation section 51.

As described above, in accordance with the attachment operation of the cutter unit 40 onto the cutter carriage 41, the cutter carriage 41 comes into contact with the contact section 56C and, by this, the base section 56 moves from the non-exposed position P32 to the exposed position P31 against the biasing force of the biasing section 58. By this, the cutter unit 40 enters an exposed state in which the cutter blade 50 is exposed from the cutter case 53. In this way, the cutter unit 40 is brought into the exposed state in accordance with the attachment operation to the cutter carriage 41. The exposed state is a state in which the cutter blade 50 is exposed.

Next, a detachment operation of detaching the cutter unit 40 from the cutter carriage 41 is performed when the unit fixing section 61 is at the fixed position P21. Specifically, the unit fixing section 61 rotates from the fixed position P21 toward the release position P22 in accordance with a detachment operation of detaching the cutter unit 40 from the cutter carriage 41.

In such a case, as shown in FIG. 10, the protrusion section 61E retreats from the first opening section 55A, so that the protrusion section 61E does not contact the contact section 56C. By this, the cutter unit 40 moves from the exposed position P31 to the non-exposed position P32 by the biasing force of the biasing section 58 and, by this, the cutter blade 50 held by the base section 56 is not exposed from the cutter accommodation section 51.

As described above, in accordance with the detachment operation of detaching the cutter unit 40 from the cutter carriage 41, the cutter carriage 41 and the contact section 56C do not contact each other. In this case, the base section 56 moves from the exposed position P31 to the non-exposed position P32 under the biasing force of the biasing section 58. By this, the cutter unit 40 is in the non-exposed state in which the cutter blade 50 is not exposed from the cutter case 53. In this way, the cutter unit 40 is brought into the non-exposed state in accordance with the detachment operation of detaching it from the cutter carriage 41. The non-exposed state is a state where the cutter blade 50 is not exposed.

### Effects of the First Embodiment

Effects of the first embodiment will be described.

(1-1) The cutter blade 50 enters the exposed state, in which the cutter blade 50 is exposed, in accordance with the attachment operation of attaching the cutter unit 40 to the cutter carriage 41. The cutter blade 50 enters the non-exposed state, in which the cutter blade 50 is not exposed, in accordance with the detachment operation of detaching the cutter unit 40 from the cutter carriage 41. According to this configuration, it is possible to process the medium 90 by exposing the cutter blade 50 in accordance with the attachment operation of attaching the cutter unit 40 to the cutter carriage 41.

On the other hand, in accordance with the detachment operation of the cutter unit 40 from the cutter carriage 41, the cutter blade 50 is not exposed. Therefore, it is possible to improve the safety of the cutter blade 50 when the cutter blade 50 is replaced.

(1-2) The protrusion section 61E and the contact section 56C come into contact with each other in accordance with the attachment operation of attaching the cutter unit 40 to the cutter carriage 41. In this case, the exposed state is achieved by moving the base section 56 to the exposed position P31 against the biasing force of the biasing section 58. By this, the medium 90 can be processed by exposing the cutter blade 50.

On the other hand, in accordance with the detachment operation of detaching the cutter unit 40 from the cutter carriage 41, the protrusion section 61E and the contact section 56C do not contact each other. In this case, the base section 56 is moved to the non-exposed position P32 by the biasing force of the biasing section 58, so that the non-exposed state is established. Therefore, it is possible to improve the safety of the cutter blade 50 when the cutter blade 50 is replaced.

(1-3) When the cutter unit 40 is mounted on the cutter carriage 41, the contact section 56C does not protrude from the front face of the cutter unit 40. By this, an erroneous operation can be suppressed. Therefore, it is possible to improve the safety of the cutter blade 50 when the cutter blade 50 is replaced.

(1-4) The replacement unit accommodation section 39 can accommodate the replacement cutter unit 40. According to this configuration, it is possible to easily replace the cutter unit 40 by taking out the replacement cutter unit 40 out of the replacement unit accommodation section 39.

### Second Embodiment

Next, a second embodiment will be described. In the following description, redundant descriptions of configurations identical to those of the previously described embodiment will be omitted or simplified, and configurations that differ from the previously described embodiment will be detailed.

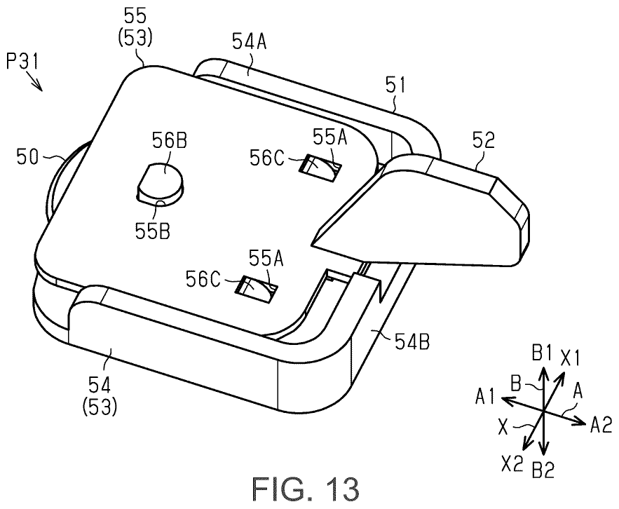

As shown in FIGS. 13 to 16, in the second embodiment, the cover 55 includes a displacement section 55C. That is, the cutter unit 40 includes the displacement section 55C. The displacement section 55C protrudes from the bottom surface of the cover 55 in the second intersecting direction B2. The displacement section 55C is positioned on the retraction direction A2 side of the cover 55. The case 54 and the cover 55 are not fixed to each other. The cover 55 and the base section 56 are fixed to each other. Therefore, the cover 55 and the base section 56 move in conjunction with each other. That is, the displacement section 55C is displaced in conjunction with the base section 56.

The cover 55 and the base section 56 integrally move in the advance/retract direction A. That is, the cutter holding section 56B and the contact section 56C are not movable relative to the cover 55. The first opening section 55A may not have an elongated hole shape. The second opening section 55B may not necessarily have an elongated hole shape.

The base section 56 is movable between the exposed position P31 and the non-exposed position P32 in a state of being accommodated in the case 54. The exposed position P31 is a position at which the cutter blade 50 is exposed. The non-exposed position P32 is a position in which the cutter blade 50 is not exposed.

The case 54 includes a locking section 54C. The locking section 54C is configured to protrude in the first intersecting direction B1 the upper surface of the case 54. In conjunction with the base section 56, the displacement section 55C moves along the advance/retract direction A over the locking section 54C. The locking section 54C locks with the displacement section 55C in the exposed position P31 and in the non-exposed position P32.

As described above, the exposed position P31 is a position in which the displacement section 55C is arranged at the advance direction A1 side of the locking section 54C. The non-exposed position P32 is a position in which the displacement section 55C is arranged at the retraction direction A2 side of the locking section 54C. The cutter unit 40 may not include the biasing section 58.

### Operation of the Second Embodiment

The operation of the second embodiment will be described.

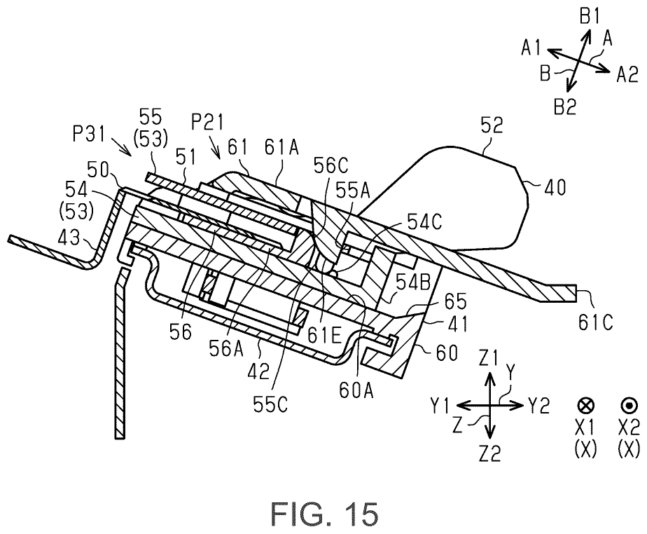

As shown in FIG. 15, in accordance with an attachment operation of attaching the cutter unit 40 to the cutter carriage 41, the unit fixing section 61 rotates from the release position P22 toward the fixed position P21, whereupon the protrusion section 61E comes into contact with the contact section 56C. That is, the contact section 56C comes into contact with the cutter carriage 41 in accordance with the attachment operation of the cutter unit 40 to the cutter carriage 41.

When the unit fixing section 61 rotates from the release position P22 to the fixed position P21, the protrusion section 61E presses the contact section 56C, resulting in the cover 55 and the base section 56 moving in the advance direction A1.

In this case, the displacement section 55C moves over the locking section 54C toward the advance direction A1 and moves to the advance direction A1 side of the locking section 54C. By this, the cutter blade 50 held by the base section 56 is exposed from the cutter accommodation section 51. In this way, the cutter unit 40 moves from the non-exposed position P32 to the exposed position P31.

As described above, in accordance with an attachment operation of attaching the cutter unit 40 to the cutter carriage 41, the cutter carriage 41 and the contact section 56C come into contact with each other, so that the displacement section 55C moves over the locking section 54C and the base section 56 becomes disposed at the exposed position P31. By this, the cutter unit 40 is in an exposed state in which the cutter blade 50 is exposed from the case 54.

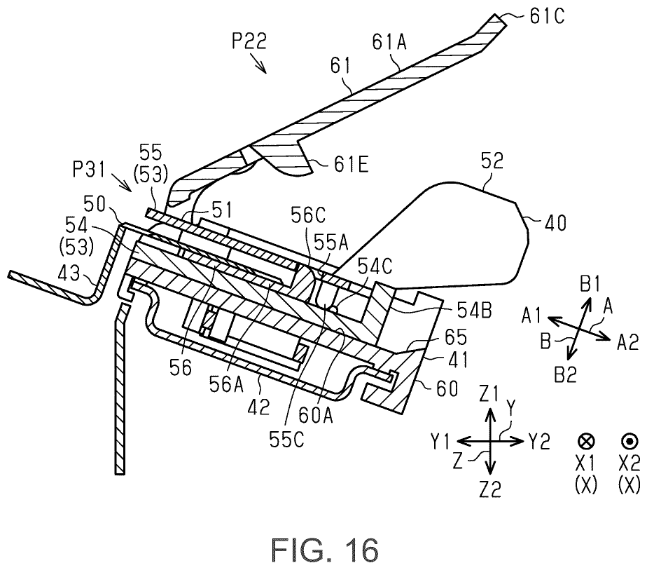

Next, as shown in FIG. 16, a detachment operation of detaching the cutter unit 40 from the cutter carriage 41 is performed. Specifically, the unit fixing section 61 rotates from the fixed position P21 to the release position P22 in accordance with the detachment operation of detaching the cutter unit 40 from the cutter carriage 41.

When the unit fixing section 61 is at the release position P22, the cutter unit 40 is removed from the cutter carriage 41. In this case, when the cutter unit 40 is moved in the retraction direction A2 while the positioning section 52 is being gripped, the end section 54B comes into contact with the inclined section 65. By this, pressure is applied to the case 54 in the advance direction A1, and the cover 55 and the base section 56 move in the retraction direction A2 with respect to the case 54.

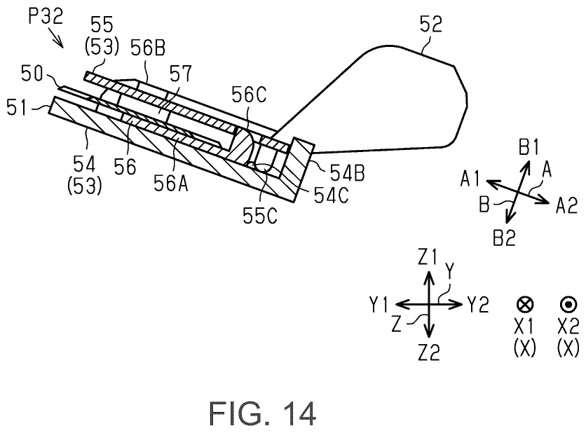

In this case, as shown in FIG. 14, the displacement section 55C moves over the locking section 54C toward the retraction direction A2 and moves to the retraction direction A2 side of the locking section 54C. By this, the cutter blade 50 held by the base section 56 is not exposed from the cutter accommodation section 51. In this way, the cutter unit 40 moves from the exposed position P31 to the non-exposed position P32.

As described above, in accordance with a detachment operation of detaching the cutter unit 40 from the cutter carriage 41, the cutter carriage 41 does not contact the contact section 56C, and the end section 54B of the case 54 comes into contact with the inclined section 65. By this, the displacement section 55C moves over the locking section 54C, and the base section 56 is disposed at the non-exposed position P32. In this case, the cutter unit 40 is in a non-exposed state in which the cutter blade 50 is not exposed from the case 54.

### Effects of the Second Embodiment

Effects of the second embodiment will be described.

(2-1) The protrusion section 61E and the contact section 56C come into contact with each other in accordance with the attachment operation of attaching the cutter unit 40 to the cutter carriage 41. In this case, the displacement section 55C moves over the locking section 54C and the base section 56 is arranged at the exposed position P31, so that the base section 56 enters the exposed state. By this, the medium 90 can be processed by exposing the cutter blade 50.

On the other hand, in accordance with the detachment operation of detaching the cutter unit 40 from the cutter carriage 41, the protrusion section 61E and the contact section 56C do not contact each other. In this case, the displacement section 55C moves over the locking section 54C and the base section 56 is disposed at the non-exposed position P32, whereby the non-exposed state is achieved. Therefore, it is possible to improve the safety of the cutter blade 50 when the cutter blade 50 is replaced.

### Third Embodiment

Next, a third embodiment will be described.

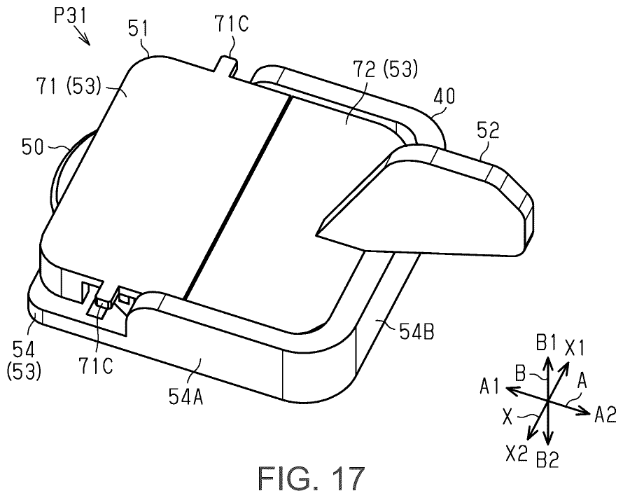

As shown in FIGS. 17 to 21, in the third embodiment, the cutter case 53 includes a first cover 71 and a second cover 72 instead of the cover 55. That is, the cutter unit 40 includes the first cover 71 and the second cover 72.

The first cover 71 is positioned further in the advance direction A1 than the second cover 72. The second cover 72 includes a positioning section 52. The second cover 72 is fixed to the case 54. The first cover 71 is not fixed to the case 54 and the second cover 72.

Together with the case 54, the first cover 71 and the second cover 72 accommodate the cutter blade 50 and the biasing section 58. The upper surfaces of the first cover 71 and the second cover 72 are planar. That is, the surfaces of the first cover 71 and the second cover 72 are flat.

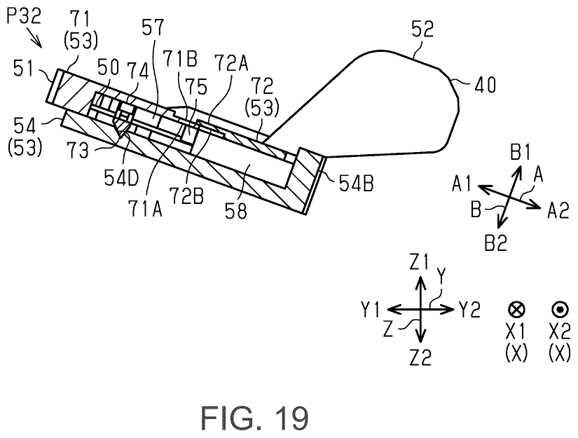

As shown in FIG. 19, the first cover 71 includes a first end section 71A and a first cutout section 71B. The first end section 71A is an end section of the first cover 71 in the retraction direction A2. The first cutout section 71B is provided in the first end section 71A. The first cutout section 71B is provided at the first intersecting direction B1 side of the first cover 71.

The second cover 72 includes a second end section 72A and a second cutout section 72B. The second end section 72A is an end section of the second cover 72 in the advance direction A1. The second cutout section 72B is provided in the second end section 72A. The second cutout section 72B is provided on the second intersecting direction B2 side of the second cover 72.

The first cover 71 is movable along the advance/retract direction A. The first cover 71 is movable between the exposed position P31 and the non-exposed position P32. The exposed position P31 is a position at which the cutter blade 50 is exposed. The non-exposed position P32 is a position in which the cutter blade 50 is not exposed.

The first cover 71 and the second cover 72 are disposed such that the first end section 71A and the second end section 72A overlap each other in the intersecting direction B. Specifically, the first end section 71A and the second end section 72A are disposed so as to overlap each other in the intersecting direction B in both of the case in which the first cover 71 is disposed at the exposed position P31 and the case in which the first cover 71 is disposed at the non-exposed position P32. By this, even when the first cover 71 is moved to the exposed position P31, the inside of the cutter case 53 is not exposed in the first intersecting direction B1. By this, it is possible to avoid that foreign matter enters the interior of the cutter case 53, and it is possible to improve the safety of the cutter blade 50 when the cutter blade 50 is replaced.

The case 54 is configured to hold the cutter blade 50. The cutter blade 50 is fixed to the case 54 from the first intersecting direction B1 by the fixing member 57. The case 54 includes an engagement groove 54D. The engagement groove 54D is a groove provided on the upper surface of the case 54. The engagement groove 54D is engageable with a restricting section 73 (to be described later).

The cutter unit 40 includes the restricting section 73, a restricting elastic member 74, and a biased section 75. The restricting section 73, the restricting elastic member 74, and the biased section 75 are provided to the first cover 71.

The restricting section 73 regulates movement of the first cover 71 by engaging with the engagement groove 54D. The restricting section 73 may be a lock pin. The restricting elastic member 74 is provided between the bottom surface of the first cover 71 and the restricting section 73. The restricting elastic member 74 biases the restricting section 73 in the second intersecting direction B2.

The restricting section 73 engages with the engagement groove 54D when the first cover 71 is disposed at the non-exposed position P32. The restricting section 73 is disengaged from the engagement groove 54D when the first cover 71 is disposed at the exposed position P31.

The biased section 75 is provided so as to protrude from the bottom surface of the first cover 71 in the second intersecting direction B2. The biased section 75 receives a biasing force from the biasing section 58. The biasing section 58 biases the first cover 71 in the advance direction A1 with respect to the case 54 and the second cover 72 via the biased section 75.

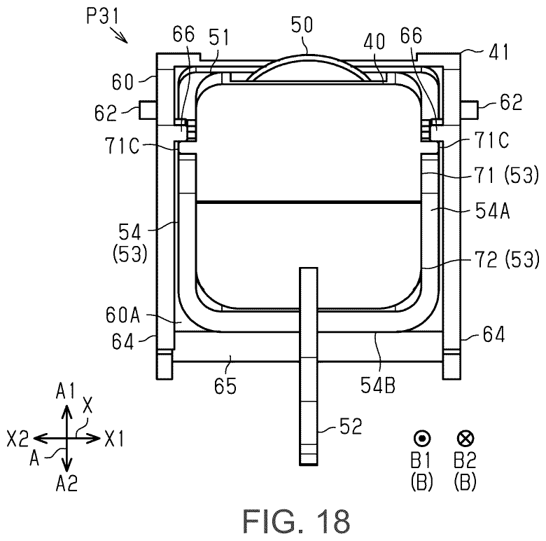

As shown in FIG. 18, the first cover 71 includes an engagement section 71C. The first cover 71 includes a pair of engagement sections 71C. The pair of engagement sections 71C are arranged in the widthwise direction X. The pair of engagement sections 71C are configured to protrude outward in the widthwise direction X at both widthwise direction X end sections of the first cover 71.

The cutter carriage 41 includes an engaged section 66. The cutter carriage 41 includes a pair of engaged sections 66. The pair of engaged sections 66 are arranged in the widthwise direction X. The pair of engaged sections 66 are provided so as to protrude inward in the widthwise direction X from respective ones of the pair of unit guide sections 64. The engaged section 66 is provided on the advance direction A1 side of the unit holding section 60. The engaged section 66 is engageable with the engagement section 71C.

When the cutter unit 40 moves from the non-exposed position P32 to the exposed position P31, the engagement section 71C engages with the engaged section 66. By this, as the cutter unit 40 moves in the advance direction A1, the first cover 71 moves in the retraction direction A2 with respect to the case 54 and the second cover 72 against the biasing force of the biasing section 58.

### Operation of the Third Embodiment

The operation of the third embodiment will be described.

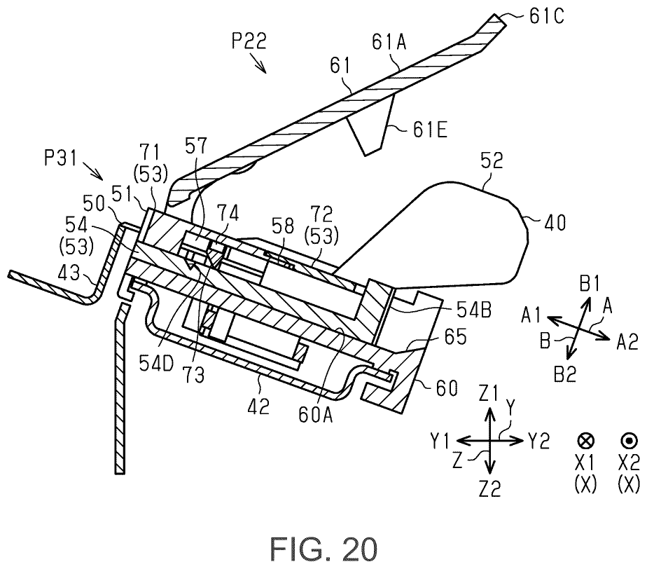

As shown in FIG. 20, when the unit fixing section 61 is at the release position P22, the attachment operation of attaching the cutter unit 40 to the cutter carriage 41 is performed. Specifically, when the unit fixing section 61 is at the release position P22, the cutter unit 40 is held in the holding region 60A of the cutter carriage 41 from the retraction direction A2 side.

In such a case, as the cutter unit 40 moves in the advance direction A1 in the holding region 60A, the engagement section 71C engages with the engaged section 66. By this, the first cover 71 moves in the retraction direction A2 against the biasing force of the biasing section 58, and the restricting section 73 separates from the engagement groove 54D. By this, the cutter unit 40 is disposed at the exposed position P31.

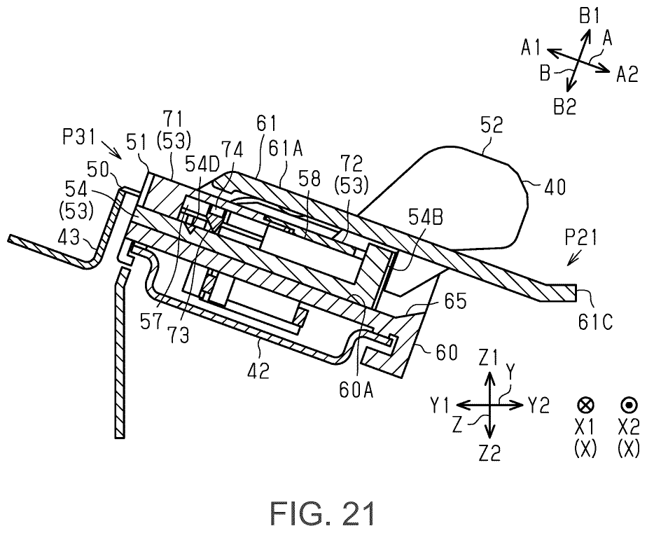

As shown in FIG. 21, the unit fixing section 61 rotates from the release position P22 to the fixed position P21. By this, the cutter unit 40 is fixed to the cutter carriage 41 in a state of being disposed at the exposed position P31.

In this way, the engagement section 71C engages with the engaged section 66 in accordance with the attachment operation of attaching the cutter unit 40 to the cutter carriage 41. By this, the first cover 71 moves to the exposed position P31 against the biasing force of the biasing section 58, and the cutter blade 50 enters an exposed state of being exposed from the first cover 71.

Next, a detachment operation of detaching the cutter unit 40 from the cutter carriage 41 is performed when the unit fixing section 61 is at the fixed position P21. Specifically, the unit fixing section 61 rotates from the fixed position P21 to the release position P22. When the unit fixing section 61 is at the release position P22, the cutter unit 40 is removed from the cutter carriage 41.

In this case, as shown in FIG. 19, when the positioning section 52 is gripped and the cutter unit 40 is moved in the retraction direction A2, the engagement section 71C of the cutter unit 40 does not engage with the engaged section 66. By this, the restricting section 73 engages with the engagement groove 54D by the biasing force of the biasing section 58, and the first cover 71 moves in the advance direction A1. By this, the cutter unit 40 is disposed at the non-exposed position P32.

In this way, in accordance with the detachment operation of detaching from the cutter carriage 41, the engagement section 71C does not engage with the engaged section 66. The cutter unit 40 is such that in such a case the first cover 71 is moved to the non-exposed position P32 by the biasing force of the biasing section 58, and the cutter unit 40 enters the non-exposed state in which the cutter blade 50 is not exposed from the first cover 71.

### Effects of the Third Embodiment

Effects of the third embodiment will be described.

(3-1) The engagement section 71C engages with the engaged section 66 in accordance with the attachment operation of attaching the cutter unit 40 to the cutter carriage 41. In this case, the first cover 71 is moved to the exposed position P31 against the biasing force of the biasing section 58 to be in the exposed state. By this, the medium 90 can be processed by exposing the cutter blade 50.

On the other hand, in accordance with the detachment operation of detaching the cutter unit 40 from the cutter carriage 41, the engagement section 71C does not engage with the engaged section 66. In this case, the first cover 71 is moved to the non-exposed position P32 by the biasing force of the biasing section 58, so that the first cover 71 is brought into the non-exposed state. Therefore, it is possible to improve the safety of the cutter blade 50 when the cutter blade 50 is replaced.

(3-2) The restricting section 73 engages with the engagement groove 54D by movement of the first cover 71 to the non-exposed position P32, and disengages from the engagement groove 54D by movement of the first cover 71 to the exposed position P31. According to this configuration, the movement of the first cover 71 can be regulated in the non-exposed position P32 by the restricting section 73 engaging with the engagement groove 54D. Therefore, it is possible to improve the safety of the cutter blade 50 when the cutter blade 50 is replaced.

(3-3) The surface of the first cover 71 is flat. By this, an erroneous operation can be suppressed. Therefore, it is possible to improve the safety of the cutter blade 50 when the cutter blade 50 is replaced.

### Fourth Embodiment

Next, a fourth embodiment will be described.

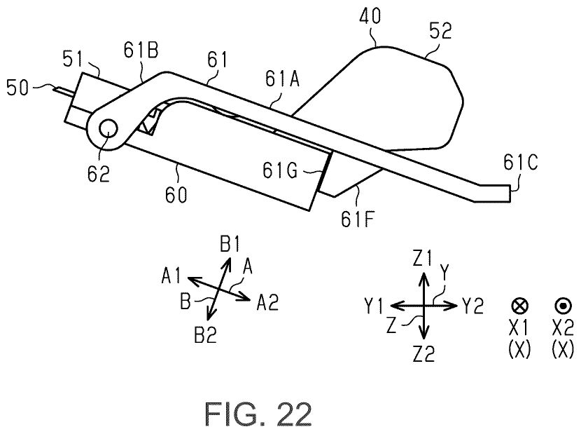

As shown in FIG. 22, in the fourth embodiment, the unit fixing section 61 includes an attachment operation restricting section 61F. That is, the cutter carriage 41 includes the attachment operation restricting section 61F. The attachment operation restricting section 61F is provided so as to protrude from the bottom surface of the main body section 61A in the second intersecting direction B2.

The attachment operation restricting section 61F includes a restriction surface 61G. The restriction surface 61G is a surface located on the advance direction A1 side of the attachment operation restricting section 61F. The restriction surface 61G is a surface facing the advance direction A1.

When the cutter unit 40 is not properly arranged in the holding region 60A, the restriction surface 61G abuts against the cutter unit 40. By this, the restriction surface 61G regulates the movement of the unit fixing section 61 to the fixed position P21.

In this manner, when the cutter unit 40 is not positioned in the holding region 60A, then the attachment operation restricting section 61F restricts the attachment operation of attaching the cutter unit 40 onto the cutter carriage 41 in response to an attachment operation of attaching the cutter unit 40 onto the cutter carriage 41.

### Effects of the Fourth Embodiment

Effects of the fourth embodiment will be described.

(4-1) In a case where the cutter unit 40 is not appropriately disposed in the holding region 60A, then the attachment operation restricting section 61F restricts the attachment operation of the cutter unit 40 to the cutter carriage 41 in response to an attachment operation of attaching the cutter unit 40 to the cutter carriage 41. According to this configuration, if the cutter unit 40 is not properly positioned in the holding region 60A, the attachment operation of attaching the cutter unit 40 onto the cutter carriage 41 is restricted. By this, erroneous operations can be suppressed. Therefore, it is possible to improve the safety of the cutter blade 50 when the cutter blade 50 is replaced.

### Modifications

The embodiment can be implemented with the following modifications. The embodiments and the following modifications can be implemented in combination with each other as long as there is no technical contradiction.
In the first embodiment and the second embodiment, the contact section 56C may not be configured to protrude in the first intersecting direction B1 as long as the contact section 56C comes into contact with the cutter carriage 41 in accordance with movement of the unit fixing section 61 to the fixed position P21.
In the first embodiment and the second embodiment, the protrusion section 61E may not be provided as long as the configuration is such that the cutter carriage 41 comes into contact with the contact section 56C in accordance with movement of the unit fixing section 61 to the fixed position P21. That is, the cutter carriage 41 may include a portion which comes into contact with the contact section 56C.
In the second embodiment, the displacement section 55C may be provided on the base section 56. The cover 55 and the base section 56 may be integrally provided.
In the second embodiment, the locking section 54C may lock the case 54 in at least one of the exposed position P31 and the non-exposed position P32. In such a case, the locking section 54C and the displacement section 55C may be arbitrarily configured. As a specific example, the locking section 54C may not protrude in the first intersecting direction B1, and may have a groove shape.
In the third embodiment, as long as it is a configuration in which the engagement section 71C engages with the engaged section 66 in accordance with the movement of the first cover 71 in the advance/retract direction A, the engagement section 71C and the engaged section 66 may be arbitrarily configured.
In the third embodiment, the restricting section 73 may engage with the engagement groove 54D when the first cover 71 moves to the non-exposed position P32, and may disengage from the engagement groove 54D when the first cover 71 moves to the exposed position P31.
In the third embodiment, the upper surfaces of the first cover 71 and the second cover 72 may not have a planar shape. The upper surface of the first cover 71 and the upper surface of the second cover 72 are at the same surface position, but need not be at the same surface position.
In the third embodiment, the case 54 and the second cover 72 may be integrally provided. The cutter case 53 may include the second cover 72, or may not include the second cover 72. The first cover 71 corresponds to an example of a cover.
In the embodiment described above, the replacement unit accommodation section 39 may be provided at an arbitrary position as long as the user can access the replacement unit accommodation section 39. As a specific example, the replacement unit accommodation section 39 may be provided in the vicinity of a replaceable ink cartridge. The replacement unit accommodation section 39 may be provided in the vicinity of a replaceable waste liquid unit. In this way, it is possible to remove the replacement cutter unit 40 when performing maintenance on the recording device 10. The replacement unit accommodation section 39 may be provided in the accommodation cassette 20. In this way, the replacement cutter unit 40 can be removed when the roll paper 91 is stored in the accommodation cassette 20. The replacement unit accommodation section 39 may be provided at an arbitrary position of the housing 11. The replacement unit accommodation section 39 may be provided on any of the left side surface 14, the right side surface 15, the bottom surface 16, or the top surface 17 of the housing 11.
In the described embodiment, the non-exposed position P32 may be any position, as long as, when viewed from the intersecting direction B, the cutter blade 50 does not protrude from the cutter accommodation section 51 in the advance direction A1. Therefore, the non-exposed position P32 may be a position at which the cutter blade 50 is exposed from the cutter accommodation section 51 or a position at which the cutter blade 50 is not exposed from the cutter accommodation section 51. That is, the exposed position P31 may be a protruding position in which the cutter blade 50 protrudes from the cutter accommodation section 51 in the advance direction A1 when viewed from the intersecting direction B. The non-exposed position P32 may be a non-protruding position at which the cutter blade 50 does not protrude from the cutter accommodation section 51 in the advance direction A1 when viewed from the intersecting direction B.
In the embodiment described above, the attachment operation of attaching the cutter unit 40 on the cutter carriage 41 may be at least one of the operation of placing the cutter unit 40 on the cutter carriage 41 or the operation of moving the unit fixing section 61 to the fixed position P21.
In the above-described embodiment, the detachment operation of detaching the cutter unit 40 from the cutter carriage 41 may be at least one of the operation of moving the unit fixing section 61 to the release position P22 or the operation of taking out the cutter unit 40 from the cutter carriage 41.
A lateral type printer may be adopted as the recording device 10. A lateral type printer is a printer in which the recording carriage 36 is movable in two directions of a main scanning direction and a sub-scanning direction.
The cutter blade 50 is not limited to a rotary blade. The cutter blade 50 may be, for example, a plate-shaped cutter blade, or may be configured to cut the medium 90 by a pair of rotary cutter blades. The cutter unit 40 includes a cutter blade 50 that cuts the medium 90, but this is not a limitation. For example, the cutter unit 40 may include a cutter blade that processes the medium 90 so as to form a crease in the medium 90. As described above, the cutter unit 40 may be a unit having a cutter blade for processing the medium 90 in the transport path 24. That is, recording device 10 may include a processing unit.
The recording device 10 may be configured to record an image on at least one of the roll paper 91 or the paper sheet 92 as the medium 90. The medium 90 may be of any type as long as it can be processed by the cutter blade 50 in the recording device 10. The medium 90 may be a paper sheet, a film or sheet made of a resin, a resin-metal composite film, a laminate film, a woven fabric, a nonwoven fabric, a metal foil, a metal film, a ceramic sheet, clothing, or the like.
The liquid can be arbitrarily selected as long as it can record on the medium 90 by being deposited on the medium 90. For example, the ink includes an ink in which particles, such as a pigment or metal particles, of a functional material made of a solid material are dissolved, dispersed, or mixed in a solvent, and includes various compositions such as water-based ink, oil-based ink, gel ink, and hot-melt ink.
The recording device 10 is not limited to being an inkjet printer and may be a dot impact printer. The recording method of recording device 10 may be a laser method instead of the ink jet method.
In this specification, the term “at least one of” refers to one or more of the desired alternatives. As an example, if the number of options is two, then the phrase “at least one of” as used herein means only one option or both of the two options. As another example, if the number of options is three or more, then the phrase “at least one of” as used herein means only one option or any combination of two or more options.

### Supplementary Notes

Hereinafter, technical ideas grasped from the above-described embodiment and modifications, and their operations and effects will be described. The present technical concept and its operation effects can be combined with each other within a technically consistent range.

(A) A recording device includes a transport section that transports a medium in a transport direction along a transport path; a recording section that records an image on the medium transported by the transport section; a cutter unit including a cutter blade for processing the medium in the transport path; and a cutter carriage configured to move the cutter unit in a widthwise direction intersecting the transport direction, wherein the cutter unit is attachable to and detachable from the cutter carriage and, in accordance with an attachment operation of attaching the cutter unit to the cutter carriage, the cutter unit enters an exposed state in which the cutter blade becomes exposed and, in accordance with a detachment operation of detaching the cutter unit from the cutter carriage, enters a non-exposed state in which the cutter blade is not exposed.

According to this configuration, it is possible to process the medium by exposing the cutter blade in accordance with the attachment operation of attaching the cutter unit to the cutter carriage. On the other hand, in accordance with the detachment operation of the cutter unit from the cutter carriage, the cutter blade is not exposed. Therefore, it is possible to improve the safety of the cutter blade when the cutter blade is replaced.

(B) The recording device may be such that the cutter unit includes a base section that holds the cutter blade, a cutter case that accommodates the base section, and a biasing section that biases the base section with respect to the cutter case, in a state in which the base section is accommodated in the cutter case, the base section is movable between an exposed position in which the cutter blade is exposed and a non-exposed position in which the cutter blade is not exposed, the base section includes a contact section that, in accordance with an attachment operation of attaching the cutter unit to the cutter carriage, comes into contact with the cutter carriage, and the cutter unit is such that when the cutter carriage and the contact section come into contact with each other in accordance with the attachment operation to the cutter carriage, the base section is moved against biasing force from the biasing section into the exposed position and the cutter blade enters the exposed state of being exposed from the cutter case and when, in accordance with the detachment operation from the cutter carriage, the cutter carriage and the contact section do not contact each other, the base section is moved by the biasing force of the biasing section to the non-exposed position and the cutter blade enters the non-exposed state in which the cutter blade is not exposed from the cutter case.

According to this configuration, the cutter carriage and the contact section come into contact with each other in accordance with the attachment operation of attaching the cutter unit to the cutter carriage. In this case, the exposed state is achieved by moving the base section to the exposed position against the biasing force of the biasing section. By this, it is possible to process the medium by exposing the cutter blade.

On the other hand, in accordance with the detachment operation of detaching the cutter unit from the cutter carriage, the cutter carriage and the contact section do not contact each other. In this case, the base section is moved to the non-exposed position by the biasing force of the biasing section, so that the non-exposed state is achieved. Therefore, it is possible to improve the safety of the cutter blade when the cutter blade is replaced.

(C) The recording device may be such that the contact section does not protrude from a surface of the cutter unit while the cutter unit is being mounted on the cutter carriage.

According to this configuration, when the cutter unit is mounted on the cutter carriage, the contact section does not protrude from the surface of the cutter unit. By this, erroneous operations can be suppressed. Therefore, it is possible to improve the safety of the cutter blade when the cutter blade is replaced.

(D) The cutter unit may include a base section that holds the cutter blade, a case that accommodates the base section, and a displacement section that is displaced in conjunction with the base section, in a state of being accommodated in the case, the base section is movable between an exposed position in which the cutter blade is exposed and a non-exposed position in which the cutter blade is not exposed, the base section includes a contact section that comes into contact with the cutter carriage in accordance with the attachment operation of attaching the cutter unit to the cutter carriage, the case includes a locking section that locks with the displacement section in at least one of the exposed position and the non-exposed position, and the cutter unit is such that when the cutter carriage and the contact section come into contact with each other in accordance with the attachment operation to the cutter carriage, the displacement section moves over the locking section so that the base section is disposed at the exposed position and also the cutter blade enters the exposed state of being exposed from the case and in accordance with the detachment operation of detaching from the cutter carriage, the displacement section moves over the locking section without the cutter carriage and the contact section contacting each other, so that the base section is positioned at the non-exposed position and also the cutter blade enters the non-exposed state in which the cutter blade is not exposed from the case.

According to this configuration, the cutter carriage and the contact section come into contact with each other in accordance with the attachment operation of attaching the cutter unit to the cutter carriage. In this case, the displacement section moves over the locking section and the base section is disposed at the exposed position, whereby the base section enters the exposed state. By this, it is possible to process the medium by exposing the cutter blade.

On the other hand, in accordance with the detachment operation of detaching the cutter unit from the cutter carriage, the cutter carriage and the contact section do not contact each other. In this case, the displacement section moves over the locking section and the base section is disposed at the non-exposed position, whereby the non-exposed state is achieved. Therefore, it is possible to improve the safety of the cutter blade when the cutter blade is replaced.

(E) The recording device may be such that the cutter unit includes a case that accommodates the cutter blade, a cover that, together with the case, accommodates the cutter blade, and a biasing section configured to bias the cover against the case, the cover is movable between an exposed position in which the cutter blade is exposed and a non-exposed position in which the cutter blade is not exposed, the cover has an engagement section, the cutter carriage has an engaged section with which the engagement section is engageable, and the cutter unit is such that in accordance with the attachment operation of attaching to the cutter carriage, the engagement section engages with the engaged section, the cover is moved to the exposed position against the biasing force of the biasing section, and the cutter blade enters the exposed state of being exposed from the cover and in accordance with a detachment operation of detaching from the cutter carriage, the engagement section does not engage with the engaged section, the cover is moved to the non-exposed position by the biasing force of the biasing section, and the cutter blade enters the non-exposed state in which the cutter blade is not exposed from the cover.

According to this configuration, the engagement section engages with the engaged section in accordance with the attachment operation of the cutter unit to the cutter carriage, and thus the cover moves to the exposed position against the biasing force of the biasing section to enter the exposed state. By this, it is possible to process the medium by exposing the cutter blade.

On the other hand, the engagement section does not engage with the engaged section in accordance with the detachment operation of detaching the cutter unit from the cutter carriage. In this case, the cover is moved to the non-exposed position by the biasing force of the biasing section, so that the cover is brought into the non-exposed state. Therefore, it is possible to improve the safety of the cutter blade when the cutter blade is replaced.

(F) The recording device may be such that the cover includes a restricting section that restricts movement of the cover, the case includes an engagement groove engageable with the restricting section, and the restricting section engages with the engagement groove when the cover moves to the non-exposed position and disengages from the engagement groove when the cover moves to the exposed position.

According to this configuration, in the non-exposed position, the movement of the cover can be restricted by the restricting section engaging with the engagement groove. Therefore, it is possible to improve the safety of the cutter blade when the cutter blade is replaced.

(G) The recording device may be such that a surface of the cover is planar.

According to this configuration, the surface of the cover is planar. By this, erroneous operations can be suppressed. Therefore, it is possible to improve the safety of the cutter blade when the cutter blade is replaced.

(H) The recording device may be such that the cutter carriage includes an attachment operation restricting section that, when the cutter unit is not disposed in a holding region, restricts the attachment operation of attaching the cutter unit to the cutter carriage in accordance with the attachment operation of the cutter unit on the cutter carriage.

According to this configuration, if the cutter unit is not positioned in the holding region, the attachment operation of attaching the cutter unit to the cutter carriage is restricted. By this, erroneous operations can be suppressed. Therefore, it is possible to improve the safety of the cutter blade when the cutter blade is replaced.

(I) The recording device may further include a housing and a replacement unit accommodation section provided in the housing and configured to accommodate a replacement cutter unit.

According to this configuration, it is possible to easily replace the replacement cutter unit by taking out the cutter unit from the replacement unit accommodation section.

What is claimed is:

1. A recording device comprising:
a transport section that transports a medium in a transport direction along a transport path;
a recording section that records an image on the medium transported by the transport section;
a cutter unit including a cutter blade for processing the medium in the transport path; and
a cutter carriage configured to move the cutter unit in a widthwise direction intersecting the transport direction, wherein
the cutter unit is attachable to and detachable from the cutter carriage and, in accordance with an attachment operation of attaching the cutter unit to the cutter carriage, the cutter unit enters an exposed state in which the cutter blade becomes exposed and, in accordance with a detachment operation of detaching the cutter unit from the cutter carriage, enters a non-exposed state in which the cutter blade is not exposed.

2. The recording device according to claim 1, wherein
the cutter unit includes
a base section that holds the cutter blade,
a cutter case that accommodates the base section, and
a biasing section that biases the base section with respect to the cutter case,
in a state in which the base section is accommodated in the cutter case, the base section is movable between an exposed position in which the cutter blade is exposed and a non-exposed position in which the cutter blade is not exposed,
the base section includes a contact section that, in accordance with an attachment operation of attaching the cutter unit to the cutter carriage, comes into contact with the cutter carriage, and
the cutter unit is such that
when the cutter carriage and the contact section come into contact with each other in accordance with the attachment operation to the cutter carriage, the base section is moved against biasing force from the biasing section into the exposed position and the cutter blade enters the exposed state of being exposed from the cutter case and
when, in accordance with the detachment operation from the cutter carriage, the cutter carriage and the contact section do not contact each other, the base section is moved by the biasing force of the biasing section to the non-exposed position and the cutter blade enters the non-exposed state in which the cutter blade is not exposed from the cutter case.

3. The recording device according to claim 2, wherein
the contact section does not protrude from a surface of the cutter unit while the cutter unit is being mounted on the cutter carriage.

4. The recording device according to claim 1, wherein
the cutter unit includes
a base section that holds the cutter blade,
a case that accommodates the base section, and
a displacement section that is displaced in conjunction with the base section,
in a state of being accommodated in the case, the base section is movable between an exposed position in which the cutter blade is exposed and a non-exposed position in which the cutter blade is not exposed,
the base section includes a contact section that comes into contact with the cutter carriage in accordance with the attachment operation of attaching the cutter unit to the cutter carriage,
the case includes a locking section that locks with the displacement section in at least one of the exposed position and the non-exposed position, and
the cutter unit is such that
when the cutter carriage and the contact section come into contact with each other in accordance with the attachment operation to the cutter carriage, the displacement section moves over the locking section so that the base section is disposed at the exposed position and also the cutter blade enters the exposed state of being exposed from the case and
in accordance with the detachment operation of detaching from the cutter carriage, the displacement section moves over the locking section without the cutter carriage and the contact section contacting each other, so that the base section is positioned at the non-exposed position and also the cutter blade enters the non-exposed state in which the cutter blade is not exposed from the case.

5. The recording device according to claim 1, wherein
the cutter unit includes
a case that accommodates the cutter blade,
a cover that, together with the case, accommodates the cutter blade, and
a biasing section configured to bias the cover against the case,
the cover is movable between an exposed position in which the cutter blade is exposed and a non-exposed position in which the cutter blade is not exposed,
the cover has an engagement section,
the cutter carriage has an engaged section with which the engagement section is engageable, and
the cutter unit is such that
in accordance with the attachment operation of attaching to the cutter carriage, the engagement section engages with the engaged section, the cover is moved to the exposed position against the biasing force of the biasing section, and the cutter blade enters the exposed state of being exposed from the cover and
in accordance with a detachment operation of detaching from the cutter carriage, the engagement section does not engage with the engaged section, the cover is moved to the non-exposed position by the biasing force of the biasing section, and the cutter blade enters the non-exposed state in which the cutter blade is not exposed from the cover.

6. The recording device according to claim 5, wherein
the cover includes a restricting section that restricts movement of the cover,
the case includes an engagement groove engageable with the restricting section, and
the restricting section engages with the engagement groove when the cover moves to the non-exposed position and disengages from the engagement groove when the cover moves to the exposed position.

7. The recording device according to claim 5, wherein
a surface of the cover is planar.

8. The recording device according to claim 1, wherein
the cutter carriage includes an attachment operation restricting section that, when the cutter unit is not disposed in a holding region, restricts the attachment operation of attaching the cutter unit to the cutter carriage in accordance with the attachment operation of the cutter unit on the cutter carriage.

9. The recording device according to claim 1, further comprising:
a housing and
a replacement unit accommodation section provided in the housing and configured to accommodate a replacement cutter unit.

10. A cutter unit attachable to and detachable from a cutter carriage with respect to a recording device,
the recording device including
a transport section that transports a medium in a transport direction along a transport path,
a recording section that records an image on the medium transported by the transport section, and
the cutter carriage, which moves the cutter unit in a widthwise direction intersecting the transport direction,
the cutter unit comprising:
a cutter blade for processing the medium in the transport path, wherein
the cutter unit enters an exposed state in which the cutter blade becomes exposed in accordance with an attachment operation of attaching the cutter unit to the cutter carriage, and enters a non-exposed state non-exposed state in which the cutter blade is not exposed in accordance with a detachment operation of detaching the cutter unit from the cutter carriage.
